(19) United States
(12) Patent Application Publication
(10) Pub. No.: US 2022/0097733 A1
(43) Pub. Date: Mar. 31, 2022

(54) INFORMATION COLLECTION DEVICE AND INFORMATION COLLECTION METHOD

(71) Applicant: Mitsubishi Electric Corporation, Tokyo (JP)

(72) Inventor: Masanobu OSAWA, Tokyo (JP)

(73) Assignee: Mitsubishi Electric Corporation, Tokyo (JP)

(21) Appl. No.: 17/426,333

(22) PCT Filed: Feb. 7, 2019
(86) PCT No.: PCT/JP2019/004404

§ 371 Date: Jul. 28, 2021

(51) Int. Cl. B60W 60/00; B60W 50/12

(52) U.S. Cl. CPC B60W 60/0051; B60W 50/12; B60W 60/001

(57) ABSTRACT

An acquisition unit for acquiring spot information generated on a basis of occurrence of a situation in which an accident may have occurred, associating information related to a spot where the situation arises with driving support state information indicating whether an autonomous driving state or a manual driving state was in use; and a classification unit for classifying, with regard to the spot information, a factor that has caused the situation in which the accident may have occurred, the situation having triggered generation of the spot information, to either an external factor or internal factor on a basis of the driving support state information included in the spot information, in which the classification unit classifies the factor that has caused the situation as the external factor with regard to the spot information in a case where the driving support state is the autonomous driving state.

### TECHNICAL FIELD

The present invention relates to an information collection device and an information collection method for acquiring spot information related to a spot where an accident may occur from an in-vehicle terminal and classifying the spot information that has been acquired depending on the factor that has caused the situation in which the accident may have occurred.

### BACKGROUND ART

In the related art, there is known technology for acquiring spot information related to a spot where an accident may occur, which is generated on the basis of the occurrence of a situation in an accident may occur, from an in-vehicle terminal such as a car navigation device and classifying the spot information that has been acquired depending on the factor that has caused the situation in which the accident may have occurred.

For example, Patent Literature 1 discloses an information distribution device for determining whether the factor that has caused a reaction related to a driver's state lies in the driving environment or the driver's inattentiveness when the reaction, which occurs when a driver senses a near miss, is detected. The information distribution device disclosed in Patent Literature 1 determines that the factor lies in the driving environment if the probability of a driver's attentive state is higher than the probability of an inattentive state, and if the probability of the driver's attentive state is less than or equal to the probability of the inattentive state, it is determined that the factor lies in the inattentiveness of the driver. Note that, in Patent Literature 1, “detecting a reaction that occurs when a driver senses a near miss” corresponds to the above-mentioned “occurrence of a situation in which an accident may occur”.

### CITATION LIST

### Patent Literature

Patent Literature 1: JP 2014-081947 A

### SUMMARY OF INVENTION

### Technical Problem

In recent years, the development of autonomous driving control has progressed, and there are an increasing number of vehicles capable of traveling by autonomous driving without requiring humans to perform driving operation. During such autonomous driving, there is a possibility of occurrence of a situation in which an accident may occur such as sudden braking or sudden steering due to an event caused by the driving environment, such as rush-out of a pedestrian, regardless of the driver's attentive state.

However, in the prior art represented y the information distribution device as disclosed in Patent Literature 1, no consideration is given to whether or not a vehicle is in autonomous driving when the spot information is classified depending on the factor that has caused the situation in which an accident may have occurred. Therefore, there is a disadvantage that spot information collected from a vehicle capable of autonomous driving is not properly classified depending on the factor that has caused the situation in which an accident may have occurred.

The present invention has been made to solve the above-mentioned disadvantage, and it is an object of the present invention to provide an information collection device capable of properly classifying spot information related to a spot where an accident may occur, which is collected from a vehicle capable of autonomous driving, depending on the factor that has caused the situation in which the accident may have and obtaining highly reliable spot information.

### Solution to Problem

An information collection device according to the present invention includes: an acquisition unit for acquiring spot information generated on a basis of occurrence of a situation in which an accident may have occurred, the spot information in which information related to a spot where the situation arises is associated with driving support state information indicating whether a driving support state when the situation has occurred is an autonomous driving state or a manual driving state; and a classification unit for classifying, with regard to the spot information, a factor that has caused the situation in which the accident may have occurred, the situation having triggered generation of the spot information, to either one of an external factor or an internal factor on a basis of the driving support state information included in the spot information acquired by the acquisition unit wherein the classification unit classifies the factor that has caused the situation as the external factor with regard to the spot information in a case where the driving support state is the autonomous driving state.

### Advantageous Effects of Invention

According to the present invention, it is possible to properly classify spot information related to a spot where an accident may occur, which is collected from a vehicle capable of autonomous driving, depending on the factor that has caused the situation in which the accident may have occurred and to obtain highly reliable spot information.

### BRIEF DESCRIPTION OF DRAWINGS

FIG. 1 is a diagram illustrating a configuration example of an information collection device according to a first embodiment.

FIG. 2 is a flowchart for explaining the operation of the information collection device according to the first embodiment.

FIG. 3 is a diagram illustrating a configuration example of an information collection device including a determination unit for determining the importance of classified spot information in the first embodiment.

FIG. 4 is a flowchart for explaining the operation of the information collection device in the case where the information collection device has the configuration as illustrated in FIG. 3 in the first embodiment.

FIGS. 5A and 5B are diagrams each illustrating an exemplary hardware configuration of the information collection device according to the first embodiment.

### DESCRIPTION OF EMBODIMENTS

Hereinafter, embodiments of the present invention will be described in detail with reference to the drawings.

First Embodiment

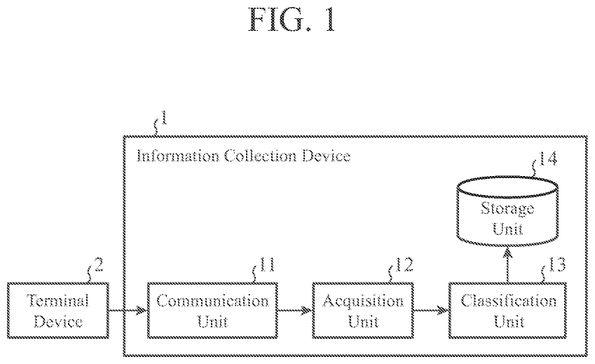

FIG. 1 is a diagram illustrating a configuration example of an information collection device 1 according to a first embodiment.

It is assumed that the information collection device 1 according to the first embodiment is a server, which is connected with one or more terminal devices 2 via a network and acquires spot information (details will be described later) from each terminal device 1. Note that only one terminal device 2 is illustrated in FIG. 1 for the sake of simplicity.

A terminal device 2 is mounted on a vehicle and generates spot information when it is determined that a situation in which an accident may occur (hereinafter referred to as an “accident-inducing situation”) has occurred at the vehicle.

Specifically, the terminal device 2 determines that accident-inducing situation has occurred when an abnormal event is detected, such as sudden brake operation or sudden steering in the vehicle, on the basis of vehicle information including brake operation information or steering angle information acquired in the vehicle.

In the first embodiment an “abnormal event” for the terminal device 2 to determine that an accident-inducing situation has occurred broadly includes events in which the terminal device 2 can determine that an accident-inducing situation has occurred in the vehicle, such as an abnormal state of the driver such as dozing, in addition to avoidance actions of the vehicle such as sudden brake operation or sudden steering as described above.

The terminal device 2 generates spot information when it is determined that an accident-inducing situation has occurred.

In the first embodiment, spot information is related to a spot where an accident may occur (hereinafter referred to as an “accident occurrence caution spot”) and the spot information includes at least the date when an abnormal event has been detected the time when the abnormal event has been detected, the position information of the vehicle at the time, information related to the driving support state at the time, and information for determining the driver's state. In the first embodiment, information for determining the driver's state specifically means at least one of an image capturing the inside of the vehicle, biological information of the driver, or information related to the drivers state. Incidentally, for example, in a case where spot information includes an image capturing the inside of the vehicle as information for determination of the driver's state, as a subsequent stage, the information collection device 1 determines the driver's state on the basis of the image capturing the inside of the vehicle. Meanwhile, information related to the driver's state indicates the driver's state such as an inattentive state or a dozing state, and, for example, the terminal device 2 can estimate the driver's state by analyzing, for example, the image capturing the inside of the vehicle.

The spot information may further include, for example, images capturing the inside and the outside of the vehicle that have been photographed during a time period which extends back into the past by a predetermined time length from the time when the abnormal event has been detected and vehicle information such as speed information and the steering angle. If the spot information does not include drivers biometric information or information related to the driver's state as information for determining the driver's state, the spot information may further include drivers biometric information or information related to the driver's state.

Note that, in the first embodiment, the position of the vehicle as of the time when an abnormal event is detected is an accident occurrence caution spot. Meanwhile, in the first embodiment, the driving support state is either the autonomous driving state or the manual driving state, and information related to the driving support. state included in the spot information indicates whether the driving support state is the autonomous driving state or the manual driving state. Hereinafter, information related to the driving support state is referred to as “driving support state information”. Details of the autonomous driving state and the manual driving state will be described later.

The terminal device 2 is, for example, a drive recorder mounted on a vehicle, having a function detecting the above-mentioned abnormal event and generating spot information. Note that this is merely an example, and the terminal device 2 is only required to have a function of detecting the above-mentioned abnormal event and generating spot information.

The information collection device 1 acquires spot information from each terminal device 2 and classifies the spot information that has been acquired depending on the factor that has caused the accident-inducing situation that has triggered generation of the spot information. Then, the information collection device adds the classification result to the spot information and stores the spot information added with the classification result in the storage unit 14.

Specifically, the information collection device 1 classifies with regard to the spot information, the factor that has caused the accident-inducing situation that has triggered generation of the spot information to either an external factor or an internal factor on the basis of the driving support state information included in the spot information acquired from each terminal device 2. In a case where the driving support state is in autonomous driving, the information collection device 1 classifies, with regard to the spot information, the factor that has caused the accident-inducing situation as an external factor.

In a case where the driving support state is the manual driving state, the information collection device 1 classifies, with regard to the spot information, the factor that has caused the accident-inducing situation to either one of an external factor or an internal factor.

The information collection device 1 adds information indicating that the factor is an external factor or information indicating that the factor is an internal factor to the spot information as classification information on the basis of the classification result and stores the information in the storage unit 14.

A configuration example of the information collection device 1 will be described.

As illustrated in FIG. 1, the information collection device 1 includes a communication unit 11, an acquisition unit 12, a classification unit 13, and a storage unit 14.

The communication unit 11 transmits and receives information to and from each terminal device 2 via the network.

The acquisition unit 12 acquires spot information transmitted from each terminal device 2 via the communication unit 11. The acquisition unit 12 outputs the spot information that has been acquired to the classification unit 13.

The classification unit 13 acquires the spot information output from the acquisition unit 12. Then, the classification unit 13 classifies, with regard to the spot information, the factor that has caused the accident-inducing situation that has triggered generation of the spot information to either an external factor or an internal factor on the basis of the driving support state information included in the spot information.

Specifically, first, the classification unit 13 determines whether or not the driving support state is the autonomous driving state on the basis of the driving support state information included in the spot information.

Here, the driving support state in the first embodiment will be described in detail. As described above, the driving support state includes the autonomous driving state and the manual driving state.

The autonomous driving state refers to a state in which an autonomous driving system mounted on the vehicle is performing all driving tasks. For example, the autonomous driving state is a state in which an autonomous driving system performs all driving tasks in driving support as the following (reference material: http://www.mlit.go.up/common/001226541.pdf).

Conditional Autonomous Driving

An autonomous driving system performs all driving tasks, but it is necessary for the driver to respond properly to intervention requests or other requests from the system.

Fully Autonomous Driving Under Certain Conditions

An autonomous driving system performs all driving tasks under certain conditions such as highways.

Fully Autonomous Driving

An autonomous driving system performs all driving tasks at all times.

On the other hand, the manual driving state, which is not the autonomous driving state, is a state in which an autonomous driving system performs some of the driving tasks or performs no driving tasks at all on the premise of driving by the driver as described below.

No Driving Support

The driver performs all driving tasks.

Driving Support

An autonomous driving system performs vehicle control in one of the front-rear direction or left-right direction. For example, any one of automated braking, auto cruise control, or lane keep assistance is performed.

Autonomous Driving Function Under Certain Conditions

Multiple types of vehicle control is performed (both auto cruise control and lane keep assistance).

Returning to the explanation of the classification unit 13.

In a case where the driving support state information indicates the autonomous driving state as a result of determination of whether or not the driving support state is the autonomous driving state, in other words, in a case where the spot information has been generated by a vehicle that is in the autonomous driving state, the classification unit 13 classifies, with regard to the spot information, the factor that has caused the accident-inducing situation that has triggered generation of the spot information as an external factor.

On the other hand, in a case where the driving support state information indicates the manual driving state, in other words, in a case where the spot information has been generated by a vehicle that is in the manual driving state, the classification unit 13 classifies, with regard to the spot information, the factor that has caused the accident-inducing situation that has triggered generation of the spot information as either an external factor or an internal factor on the basis of the spot information. It is only required for the classification unit 13 to classify the spot information to either an external factor or an internal factor using existing technology depending on the factor that has caused the accident-inducing situation that has triggered generation of the spot information.

The internal factors belong to a class indicating that the spot information has been generated as a result of occurrence of an accident-inducing situation that has been caused by a driver's state. The driver's state that has caused the accident-inducing situation refers to an abnormal state of the driver such as a state in which the driver is impatient, a slate in which the driver is dozing, or a state in which the driver's attentiveness is reduced.

The external factors belong to a class indicating that the spot information has been generated as a result of occurrence of an accident-inducing situation that has been caused by the environment outside the vehicle. The environment outside the vehicle that has caused the accident-inducing situation includes a static environment outside the vehicle and a dynamic environment outside the vehicle.

The static environment outside the vehicle includes, for example, an intersection with poor visibility, a time period with poor visibility, or weather with poor visibility such as rain, snow, or fog.

The dynamic environment outside the vehicle includes, for example, pedestrians, bicycles, or other vehicles.

The environment outside the vehicle can be determined, for example, by referring to a database (not illustrated) in which weather information is stored at the time when the terminal device 2 has detected the accident-inducing situation when generating the spot information. It is also possible to determine by existing image processing technology, for example, from an image capturing the outside of the vehicle that have been photographed during a time period which extends back into the past by a predetermined time length. For example, the terminal device 2 adds, to the spot information, the information related to the environment outside the vehicle that has been determined, and the classification unit 13 can classify the spot information depending on the information related to the environment outside the vehicle added to the spot information.

Note that the driver's condition or the environment outside the vehicle described above is merely an example. The driver's state that causes an accident-inducing situation broadly includes states that cause an accident-inducing situation. Likewise, the environment outside the vehicle that causes an accident-inducing situation broadly includes environments which cause an accident-inducing situation.

In a case where the spot information has been generated by a vehicle in the autonomous driving state, the driver is not performing driving tasks in the vehicle. Therefore, it is conceivable that the factor that has caused the accident-inducing situation is not in the driver but in the environment outside the vehicle. For example, in a case where there is a blind spot, recognition of pedestrians or the like by the autonomous driving system is delayed, which causes an accident-inducing situation. Therefore, the classification unit 13 classifies the spot information as an external factor if the spot information has been generated by a vehicle in the autonomous driving state.

On the other hand, in a case where the spot information has been generated by a vehicle in the manual driving state, it is conceivable that the factor that has caused the accident-inducing situation is in the driver or in the environment outside the vehicle. For example, in a case where the spot information has been generated by a vehicle in the manual driving state and the driver is in a dozing state in the vehicle, it is conceivable that the factor that has caused the accident-inducing situation is in the driver's state. Therefore, in this case, the classification unit 13 classifies the spot information as an internal factor.

Meanwhile, for example, in a case where the spot information has been generated by a vehicle in the manual driving state and there are more than or equal to a predetermined number of pieces of spot information acquired from terminal devices 2 mounted on a respective plurality of vehicles in the same spot or within a predetermined area, it is conceivable that the factor that has caused the accident-inducing situation can occur regardless of the driver's state or the like and occurs depending on the environment outside the vehicle such as the road condition. Therefore, in this case, the classification unit 13 classifies the spot information as an external factor.

Then, on the basis of the classification result, the classification unit 13 adds, to the spot information, the classification information indicating that the factor is an external factor or classification information indicating that the factor is an internal factor and stores the spot information added with the classification information (hereinafter referred to as “classified spot information”) in the storage unit 14.

The storage unit 14 stores the classified spot information which is added with the classification information by the classification unit 13.

Note that, in the first embodiment, the storage unit 14 is included in the information collection device 1; however, this is merely an example, and the storage unit 14 may be included in a separate device from the information collection device 1 that is external to the information collection device 1.

The classified spot information stored in the storage unit 14 is used, for example, when alert information for calling for attention of the driver who is driving a vehicle is delivered to the vehicle. To give a specific example, for example, an alert device (not illustrated) that delivers alert information to a vehicle delivers alert information for calling for attention to a vehicle that is about to pass an accident occurrence caution spot on the basis of the classified spot information indicating an external factor. This is because it is estimated that an accident is likely to occur in the environment outside the vehicle at the accident occurrence caution spot

Furthermore, for example, in a case where more than or equal to a predetermined number of pieces of classified spot information are stored in the storage unit 14 that indicate that the factors are internal factors, indicate the same accident occurrence caution spot, and pertain to the same driver, the alert device delivers alert information for calling for attention to the vehicle when the vehicle driven by the driver passes the accident occurrence caution spot. This is because it is presumed that the driver is likely to be in an accident-prone state when passing through the accident occurrence caution spot. Note that the information collection device 1 may deliver alert information as described above.

The operation of the information collection device 1 of the first embodiment will be described.

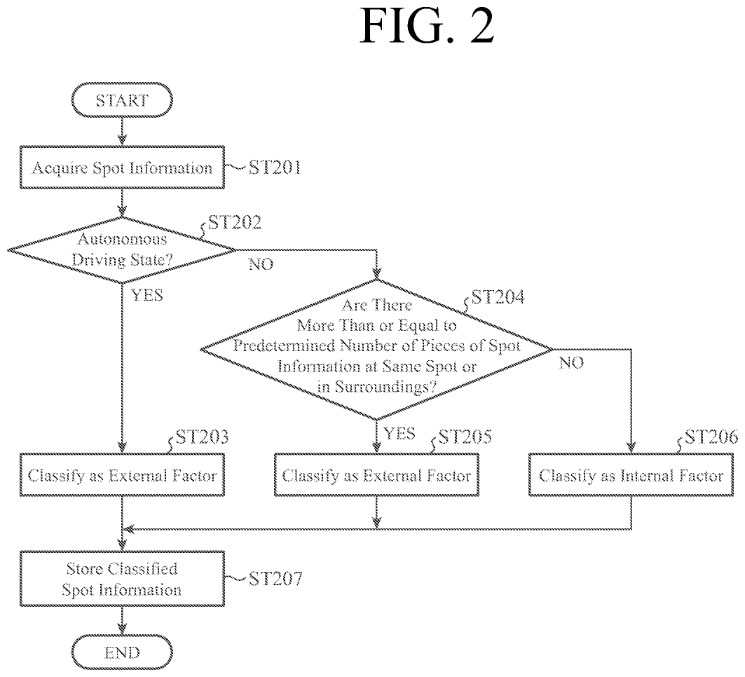

FIG. 2 is a flowchart for explaining the operation of the information collection device 1 according to the first embodiment.

The acquisition unit 12 acquires spot information transmitted from each terminal device 2 via the communication unit 11 (step ST201). The acquisition unit 12 outputs the spot information that has been acquired to the classification unit 13.

The classification unit 13 acquires the spot information acquired by the acquisition unit 12 in step ST201 and determines whether or not the driving support state is the autonomous driving state on the basis of the driving support state information included in the spot information (step ST202).

In a case where the driving support state information indicates the autonomous driving state as a result of determination of whether or not the driving support suite is the autonomous driving state, in other words, in a case where the spot information has been generated by a vehicle that is in the autonomous driving state (in a case of “YES” in step ST202), the classification unit 13 classifies, with regard to the spot information, the factor that has caused the accident-inducing situation that has triggered generation of the spot information as an external factor (step ST203).

On the other hand, in a case where the information related to the driving state indicates the manual driving state, in other words, in a case where the spot information has been generated by a vehicle that is in the manual driving state (in a case of “NO” in step ST202), the classification unit 13 classifies, with regard to the spot information, the factor that has caused the accident-inducing situation that has triggered generation of the spot information as either an external factor or an internal factor.

For example, the classification unit 13 determines whether or not there are more than or equal to a predetermined number of pieces of spot information acquired from terminal devices 2 mounted on a respective plurality of vehicles in the same spot or within a predetermined area (step ST204).

If there are more than or equal to the predetermined number of pieces of spot information acquired from the terminal devices 2 mounted on the respective plurality of vehicles in the same spot or within a predetermined area (in the case of “YES” in step ST204), the classification unit 13 classifies the spot information as an external factor (step ST205).

If there are no or less than the predetermined number of pieces of spot information acquired from the terminal devices 2 mounted on the respective plurality of vehicles in the same spot or within the predetermined area (in the case of “NO” in step ST204), the classification unit 13 classifies, with regard to the spot information, the factor that has caused the accident-inducing situation that has triggered generation of the spot information as an internal factor (step ST206).

Note that the content illustrated in step ST204 is an example of the content of the conditions for the classification unit 13 to classify, with regard to the spot information, the factor, which has caused the accident-inducing situation that has triggered generation of the spot information, as either an external factor or an internal factor on the basis of the spot information in a case where the driving support state information included in the spot information indicates the manual driving state. Not limited to the classification based on the content, the classification unit 13 may classify. with regard to the spot information, the factor that has caused the accident-inducing situation that has triggered generation of the spot information as either an external factor or an internal factor depending on the factor that has caused the accident-inducing situation that has triggered generation of the spot information.

For example, in step ST204, the classification unit 13 may classify the factor that has caused the accident-inducing situation that has triggered generation of the spot information as either an external factor or an internal factor on the basis of the spot information depending on whether or not the driver is awake, in other words, whether or not the driver is not in a dozing state. If the driver is awake (in a case of “YES” in step ST204), the classification unit 13 classifies, with regard to the spot information, the factor that has caused the accident-inducing situation that has triggered generation of the spot information as an external factor (step ST205). On the other hand, if the driver is not awake and in a dozing state (in a case of “NO” in step ST204), the classification unit 13 classifies, with regard to the spot information, the factor that has caused the accident-inducing situation that has triggered generation of the spot information as an internal factor (step ST206).

Alternatively, for example, in step ST204, the classification unit 13 may classify the factor that has caused the accident-inducing situation that has triggered generation of the spot information as either an external factor or an internal factor on the basis of the spot information depending on whether or not it is snowing heavily. If it is snowing heavily (in a case of “YES” in step ST204), the classification unit 13 classifies, with regard to the spot information, the factor that has caused the accident-inducing situation that has triggered generation of the spot information as an external factor (step ST205). On the other hand, if it is not snowing heavily (in a case of “NO” in step ST204), the classification unit 13 classifies, with regard to the spot information, the factor that has caused the accident-inducing situation that has triggered generation of the spot information as an internal factor (step ST206).

The classification unit 13 stores, in the storage unit 14, classified spot information obtained by adding, to the spot information, classification information indicating that the factor is an external factor or classification information indicating that the factor is an internal factor on the basis of the classification result in step ST203, step ST205, or step ST206 (step ST207).

In this manner, in a case where the driving support state is the autonomous driving state on the basis of the driving support state information included in the spot information that has been generated on the basis of the occurrence of the accident-inducing situation, the information collection device 1 classifies, with regard to the spot information, the factor that has caused the accident-inducing situation that has triggered generation of the spot information as an external factor.

As a result, it is possible to properly classify the spot information collected from the vehicle capable of autonomous driving depending on the factor that has caused the accident-inducing situation and to obtain highly reliable spot information.

In the above-described first embodiment, the information collection device 1 has the configuration as described with reference to FIG. 1; however, this is merely an example.

For example, the information collection device 1 may have a function of determining the importance of the classified spot information.

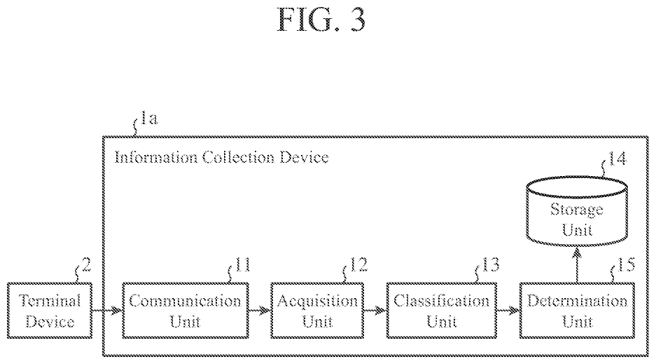

FIG. 3 is a diagram illustrating a configuration example of an information collection device 1a including a determination unit 15 for determining the importance of classified spot information in the first embodiment.

Note that, in FIG. 3, components similar to those of the information collection device 1 described with reference to FIG. 1 are denoted by the same symbol, and redundant description will be omitted.

In the first embodiment, the importance determined by the determination unit 15 is the degree of influence of an external factor on classified spot information classified as an external factor. That is, the higher the importance of the classified spot information is, the higher the influence of an external factor is, and it is more probable that an accident due to an external factor occurs at the accident occurrence caution spot indicated by the classified spot information.

For classified spot information output from the classification unit 13, the determination unit 15 determines the importance of the classified spot information. Then, the determination unit 15 adds information of the importance to the classified spot information output from the classification unit 13 and stores the classified spot information added with the information of the importance (hereinafter referred to as “importance-added classified spot information”) in the storage unit 14. The storage unit 14 stores not only the classification information but also the importance-added classified spot information that is added with the information of the importance.

Note that it is assumed in the first embodiment that the importance is defined as either “high” or “low”.

The determination unit 15 determines the importance so that, of the classified spot information classified by the classification unit 13 as an external factor, the importance of classified spot information in which the driving support state is the autonomous driving state is higher than the importance of classified spot information in which the driving support state is the manual driving state.

That is, the determination unit 15 determines the importance of classified spot information classified by the classification unit 13 as an external factor and in which the driving support state is the autonomous driving state as “high”, and the importance of classified spot information classified by the classification unit 13 as an external factor and in which the driving support state is the manual driving as “low”.

During manual driving in which the driver is responsible for driving the vehicle, whether or not an accident-inducing situation occurs depends on the driver's state. For example, even in a case where the driver is a person who is highly focused, it cannot be said that the driver can always stay highly focused, and it is possible that the driver loses focus. Therefore, it is possible that an abnormal event occurs at a spot where usually no abnormal events occur due to the fact that the driver has accidentally lost focus at that time. As a result, it is possible that spot information is generated in the terminal device 2 at a spot where usually no spot information is generated and that the spot information is classified as the spot information of an external factor in the information collection devices 1 and 1a.

Furthermore, for example, even when a driver is focused, it is possible that the driver fails to lose attention. For example, even when the driver is focused, it is possible that an abnormal event occurs at a spot where usually no abnormal events occur due to lack of attention to pedestrians at an intersection. In this case as well, as a result, it is possible that spot information is generated in the terminal device 2 at a spot where usually no spot information is generated and that the spot information is classified as the spot information of an external factor in the information collection devices 1 and 1a.

As described above, in a case of the manual driving, the way how classified spot information is generated is likely to be influenced by the driver's state. In addition, basically, it is assumed that autonomous driving systems in vehicles in autonomous driving, in which the driver is not responsible for driving the vehicle, has a higher detection ability toward the environment outside the vehicle than drivers onboard the vehicles in manual driving.

For the above reasons, it can be said that classified spot information in which the driving support state is the autonomous driving suite is more influence by external factors than classified spot information in which the driving support state is the manual driving state among the classified spot information classified by the classification unit 13 as external factors. In other words, it can be said that accidents due to external factors are more likely to occur at an accident occurrence caution spot indicated by classified spot information that has been generated due to detection of occurrence of an accident-inducing situation in a vehicle in the autonomous driving state than at an accident occurrence caution spot indicated by classified spot information that has been generated due to detection of occurrence of an accident-inducing situation in a vehicle in the manual driving state.

Therefore, the determination unit 15 determines the importance so that, of the classified spot information classified by the classification unit 13 as an external factor, the importance of classified spot information in which the driving support state is the autonomous driving state is higher than the importance of classified spot information in which the driving support state is the manual driving state.

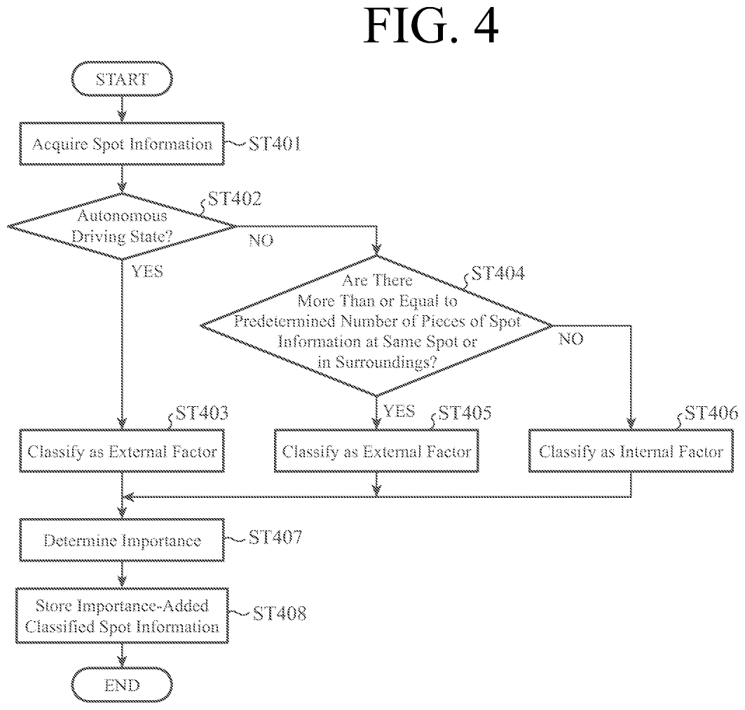

FIG. 4 is a flowchart for explaining the operation of the information collection device 1ain the case where the information collection device 1a has the configuration as illustrated in FIG. 3 in the first embodiment.

The specific operation in steps ST401 to ST406 in FIG. 4 are similar to the specific operation in steps ST201 to ST206 described in FIG. 2, and thus redundant description is omitted.

The determination unit 15 determines the importance of the classified spot information output from the classification unit 13 in step ST403, step ST405, or step ST406 (step ST407).

Specifically, the determination unit 15 determines the importance so that, of the classified spot information classified as an external factor, the importance of classified spot information in which the driving support state is the autonomous driving state is higher than the importance of classified spot information in winch the driving support state is the manual driving state.

Then, the determination unit 15 stores the importance-added classified spot information in the storage unit 14 (step ST408).

In this manner, the information collection device la includes the determination unit 15 for determining the importance of classified spot information, and the determination unit 15 can determine the importance so that, of classified spot information classified as an external factor, the importance of classified spot information in which the driving support state is the autonomous driving state is higher than the importance of classified spot information in which the driving support state is the manual driving state. As a result, it is possible to properly classify spot information collected from vehicles that are capable of autonomous driving depending on the factor that has caused the accident-inducing situation and to obtain highly reliable spot information. It is also possible to obtain spot information which allows the degree of influence of an external factor to be grasped.

Furthermore, in the information collection device 1a, the determination unit 15 stores the importance-added classified spot information in the storage unit 14. Therefore, for example, it is possible to change the degree of alert depending on the importance added to the importance-added classified spot information when the alert device or the information collection device 1a delivers alert information to a vehicle. To change the degree of alert means, for example, to change the amount of information for the alert. For example, it is possible to output alert information with more emphasis on calling for attention as the higher the importance is when the alert device or the information collection device 1a delivers alert information to a vehicle on the basis of the importance-added classified spot information that has been classified as an external factor.

The alert device or the information collection device 1a may determine whether or not to deliver alert information on the basis of the importance added to the importance-added classified spot information.

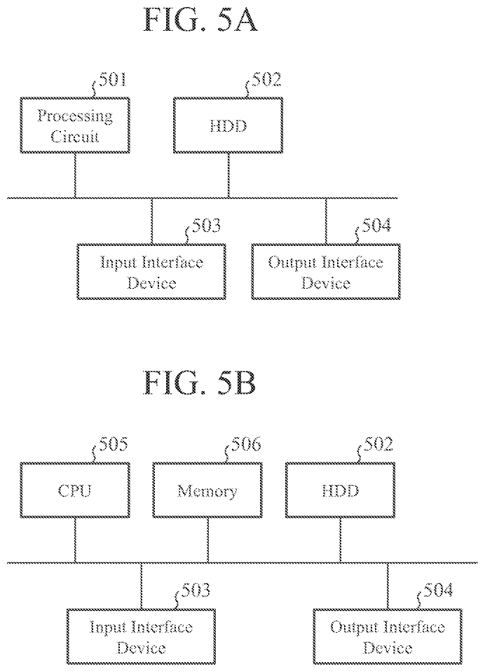

FIGS. 5A and 5B are diagrams each illustrating an exemplary hardware configuration of the information collection devices 1 and 1a according to the first embodiment.

In the first embodiment, the functions of the acquisition unit 12, the classification unit 13, and the determination unit 15 are implemented by a processing circuit 501. That is, the information collection devices 1 and 1a include the processing circuit 501 for controlling the classification of spot information acquired from the terminal device 2 depending on the factor that has caused the accident-inducing situation that has triggered generation of the spot information.

The processing circuit 501 may be dedicated hardware as illustrated in FIG. 5A or may be a central processing unit (CPU) 505 for executing a program stored in a memory 506 as illustrated in FIG. 5B.

In a case where the processing circuit 501 is dedicated hardware, the processing circuit 501 corresponds to, for example, a single circuit, a composite circuit, a programmed processor, a parallel programmed processor, an application specific integrated circuit (ASIC), a field-programmable gate array (FPGA), or a combination thereof.

In a case where the processing circuit 501 is a CPU 505, the functions of the acquisition unit 12, the classification unit 13, and the determination unit 15 are implemented by software, firmware, or a combination of software and firmware. That is, the acquisition unit 12, the classification unit 13, and the determination unit 15 are implemented by a processing circuit such as the CPU 505 or a system large-scale integration (LSI) for executing programs stored in a hard disk drive (HDD) 502, the memory 506, or the like. It is also understood that programs stored in the HDD 502, the memory 506, and the like cause a computer to execute the procedures and methods of the acquisition unit 12, the classification unit 13, and the determination unit 15. Here, the memory 506 may be, for example, a nonvolatile or volatile semiconductor memory such as a RAM, a read only memory (RDM), a flash memory, an erasable programmable read only memory (EPROM), or an electrically erasable programmable read only memory (EEPROM), a magnetic disc, a flexible disc, an optical disc, a compact disc, a mini disc, or a digital versatile disc (DVD).

Note that some of the functions of the acquisition unit 12, the classification unit 13, and the determination unit 15 may be implemented by dedicated hardware, and other functions may be implemented by software or firmware. For example, the function of the acquisition unit 12 may be implemented by the processing circuit 501 as dedicated hardware, and the function of the classification unit 13 and the determination unit 15 may be implemented by the processing circuit reading and executing a program stored in the memory 506.

Meanwhile, as the storage unit 14, the memory 506 is used. Note that this is an example, and the storage unit 14 may be implemented by the HDD 502, a solid state drive (SSD), a DVD, or the like.

The information collection devices 1 and 1a further include an input interface device 503 and an output interface device 504 for performing wired communication or wireless communication with a device such as the terminal device 2. The communication unit 11 includes the input interface device 503 and the output interface device 504.

As described above, according to the first embodiment, the information collection devices 1 and 1a each include: the acquisition unit 12 for acquiring spot information in which information related to a spot where a situation in which an accident may have occurred (accident-inducing situation), the information generated on the basis of occurrence of the accident-inducing situation, is associated with driving support state information indicating whether a driving support state when the situation has occurred is an autonomous driving state or a manual driving state; and the classification unit 13 for classifying, with regard to the spot information, a factor that has caused the accident-inducing situation having triggered generation of the spot information, to cither one of an external factor or an internal factor on the basis of the driving support state information included in the spot information acquired by the acquisition unit 12, in which the classification unit 13 classifies the factor that has caused the accident-inducing situation as an external factor with regard to the spot information in a case where the driving support state is the autonomous driving state. With this configuration, it is possible to properly classify the spot information collected from the vehicle capable of autonomous driving depending on the factor that has caused the accident-inducing situation and to obtain highly reliable spot information.

In this manner, the information collection device 1a further includes the determination unit 15 for determining the importance of spot information classified by the classification unit 13, and the determination unit 15 determines the importance so that, of spot information (classified spot information) classified as an external factor by the classification unit 13, the importance of classified spot information in which the driving support state is the autonomous driving state is higher than the importance of classified spot information in which the driving support state is the manual driving state. Therefore, it is possible to properly classify spot information collected from vehicles that are capable of autonomous driving depending on the factor that has caused the accident-inducing situation and to obtain highly reliable spot information. It is also possible to obtain spot information which allows the degree of influence of an external factor to be grasped.

Note that the present invention may include modifications of any component of the embodiments or omission of any component of the embodiments within the scope of the present invention.

### INDUSTRIAL APPLICABILITY

An information collection device according to the present invention is capable of properly classifying spot information related to a spot where an accident may occur, which is collected from a vehicle capable of autonomous driving, depending on the factor that has caused the situation in which the accident may have occurred and obtaining highly reliable spot information and thus, is applicable to an information collection device for collecting spot information related to spots, where an accident may occur, from in-vehicle terminals and classifying the spot information that has been collected depending on the factor that has caused the situation in which the accident may have occurred.

### REFERENCE SIGNS LIST

1, 1a: information collection device, 2: terminal device, 11: communication unit, 12: acquisition unit, 13: classification unit, 14: storage unit, 15: determination unit, 501: processing circuit, 502: HDD, 503: input interface device, 504: output interface device, 505: CPU, 506: memory

1. An information collection device comprising:
processing circuitry configured to:
acquire spot information generated on a basis of occurrence of a situation in which an accident may have occurred, the spot information in which information related to a spot where the situation arises is associated with driving support state information indicating whether a driving support state when the situation has occurred is an autonomous driving state or a manual driving state; and
classify, with regard to the spot information, a factor that has caused the situation in which the accident may have occurred, the situation having triggered generation of the spot information, to either one of an external factor or an internal factor on a basis of the driving support state information included in the acquired spot information,
wherein the processing circuitry classifies the factor that has caused the situation as the external factor with regard to the spot information in a case where the driving support state is the autonomous driving state.

2. The information collection device according to claim 1,
wherein the processing circuitry classifies the factor that has caused the situation to either one of the external factor or the internal factor with regard to the spot information in a case where the driving support state is the manual driving state on a basis of the spot information.

3. The information collection device according to claim 1,
wherein the processing circuitry further configured to
determine importance of the classified spot information,
wherein the processing circuitry determines the importance in such a way that, among the spot information classified as the external factor, the importance of the spot information in which the driving support state is the autonomous driving state is higher than the importance of the spot information in which the driving support state is the manual driving state.

4. An information collection method comprising:
acquiring spot information generated on a basis of occurrence of a situation in which an accident may have occurred, the spot information in which information related to a spot where the situation arises is associated with driving support state information indicating whether a driving support state when the situation has occurred is an autonomous driving state or a manual driving state;
classifying, with regard to the spot information, a factor that has caused the situation in which the accident may have occurred, the situation having triggered generation of the spot information, to either one of an external factor or an internal factor on a basis of the driving support state information included in the acquired spot information acquired; and
classifying the factor that has caused the situation as the external factor with regard to the spot information in a case where the driving support state is the autonomous driving state, in the step of classifying the factor that has caused the situation in which the accident may have occurred to either one of the external factor or the internal factor.
